(19) United States
(12) Patent Application Publication
(10) Pub. No.: US 2005/0122904 A1
(43) Pub. Date: Jun. 9, 2005

(54) Preventative congestion control for application support

(76) Inventor: Anil K. Kumar, Chandler, AZ (US)

Correspondence Address: INTEL CORPORATION, P.O. BOX 5326, SANTA CLARA, CA, 95056-5326, US

(21) Appl. No.: 10/728,676

(22) Filed: Dec. 4, 2003

(51) Int. Cl. H04L 1/00

(52) U.S. Cl. 370/230; 370/235

(57) ABSTRACT

In one embodiment, a method is provided. The method of this embodiment provides: in response, at least in part, to a request for a service from a system, determining a quality of service to assign to an application to be executed by the system to provide the service, the quality of service based, at least in part, on one or more service characteristics of the application; and allocating a set of resources to the system to execute the application, the set of resources based, at least in part, on the quality of service.

### FIELD

Embodiments of this invention relate to preventative congestion control for application support.

### BACKGROUND

Intelligent media centers (hereinafter “IMC's”) refer to devices that may execute applications, such as multimedia applications, to provide a variety of services to different clients connected to the IMC through wirelined or wireless communication channels. IMC's may comprise, for example, media center gateways (MCG), advanced STB (set top boxes), media PCs (personal computers), and access platforms (such as residential gateways). To support multiple applications that may be requested by various clients, the ability for an IMC to guarantee a certain QoS (quality of service) to each application becomes important so that requirements of protocol and processing associated with each application can be satisfied, and so that congestion on a communication channel can be controlled.

In one example of prior art, prior art IMC's may provide QoS to applications in the control plane. As opposed to the bearer plane, in which data delivery determinations may be made, the control plane may be responsible for signal processing and call control activities, such as when to set up or tear down connections, and requesting notification of specific events for further processing, for example. Using a protocol such as RSVP (Resource Reservation Protocol, or Resource Reservation Setup Protocol), for example, which may be specified in “Resource Reservation Protocol (RSVP)—Version 1 Functional Specification” published September 1997”, prior art IMC's may provide QoS by reserving resources in the control plane.

However, since the number of applications that may be active on a given channel at a given time can vary dynamically, the exact resource requirements needed for an application may not be known to an IMC at start-up of an application. Since prior art IMC's using RSVP do not provide QoS in the data forwarding path (i.e., in the bearer plane), some disadvantages may occur. For example, events related to execution of applications may be handled as the events occur, which may lead to excessive context switching (i.e., switching from one application to another application). Furthermore, if certain applications need lower latency requirements than other applications, prior art IMC's may not be capable of handling such a requirement.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 illustrates a network.

FIG. 2 illustrates a system embodiment.

FIG. 3 is a flowchart illustrating operations that may be performed according to an embodiment.

FIG. 4 is a flowchart illustrating operations that may be performed according to another embodiment.

FIG. 5 is a chart showing exemplary multimedia applications and examples of their service characteristics.

FIG. 6 is a chart representing a QoS parameters database.

FIG. 7 illustrates a communications environment having a control plane and a bearer plane.

### DETAILED DESCRIPTION

Embodiments of the present invention include various operations, which will be described below. The operations associated with embodiments of the present invention may be performed by hardware components or may be embodied in machine-executable instructions, which when executed may result in a general-purpose or special-purpose processor or logic circuits programmed with the machine-executable instructions performing the operations. Alternatively, and/or additionally, some or all of the operations may be performed by a combination of hardware and software.

Embodiments of the present invention may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments of the present invention. A machine-readable medium may include, but is not limited to, floppy diskettes, optical disks, CD-ROMs (Compact Disc-Read Only Memories), and magneto-optical disks, ROMs (Read Only Memories), RAMs (Random Access Memories), EPROMs (Erasable Programmable Read Only Memories), EEPROMs (Electrically Erasable Programmable Read Only Memories), magnetic or optical cards, flash memory, or other type of media/machine-readable medium suitable for storing such instructions.

Moreover, embodiments of the present invention may also be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection). Accordingly, as used herein, a machine-readable medium may, but is not required to, comprise such a carrier wave.

Examples described below are for illustrative purposes only, and are in no way intended to limit embodiments of the invention. Thus, where examples may be described in detail, or where a list of examples may be provided, it should be understood that the examples are not to be construed as exhaustive, and do not limit embodiments of the invention to the examples described and/or illustrated.

Introduction

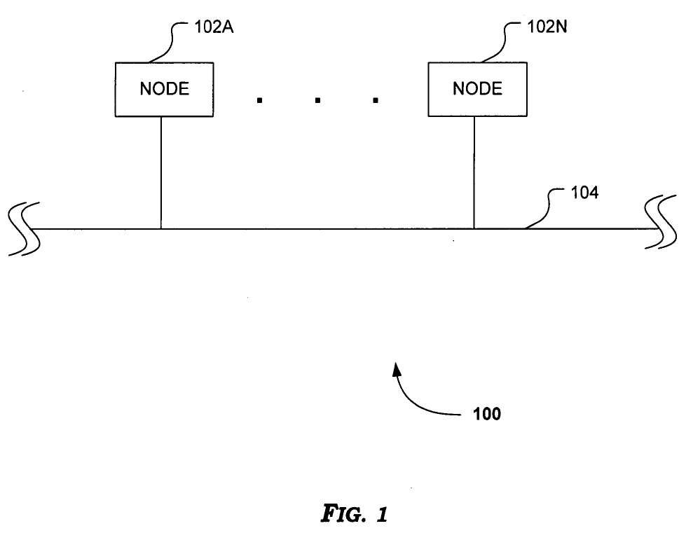

FIG. 1 illustrates one example of a network 100 in which embodiments of the invention may be carried out. Network 100 may comprise, for example, one or more computer nodes 102A . . . 102N (hereinafter “nodes”) communicatively coupled together via a communication medium 104. Nodes 102A . . . 102N may transmit and receive sets of one or more signals via medium 104 that may encode one or more packets. As used herein, a “packet” means a sequence of one or more symbols and/or values that may be encoded by one or more signals transmitted from at least one sender to at least one receiver.

As used herein, a “communication medium” 104 means a physical entity through which electromagnetic radiation may be transmitted and/or received.

Medium 104 may comprise, for example, one or more optical and/or electrical cables, although many alternatives are possible. For example, medium 104 may comprise, for example, air and/or vacuum, through which nodes 102A . . . 102N may wirelessly transmit and/or receive sets of one or more signals.

In network 100, one or more of the nodes 102A . . . 102N may comprise one or more intermediate stations (not shown), such as, for example, one or more hubs, switches, and/or routers, and medium 104 may communicatively couple together at least some of the nodes 102A . . . 102N and one or more of these intermediate stations. Additionally or alternatively, one or more of the nodes 102A . . . 102N may comprise one or more end stations (not shown). Of course, many alternatives are possible.

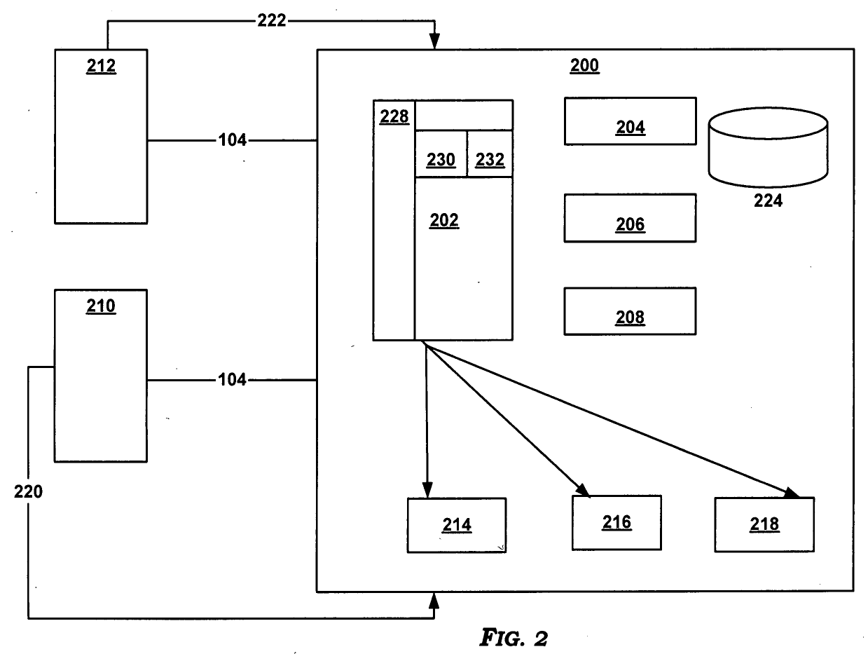

FIG. 2 illustrates a system 200 in accordance with an embodiment of the invention. In described and illustrated embodiments, system 200 may refer to a modified IMC (hereinafter “MIMC”). In embodiments of the invention, an MIMC refers to an IMC that may provide one or more services, and that may offer QoS to one or more applications based on one or more service characteristics of the one or more applications. One or more applications may be multimedia applications, for example. However, system 200 is not limited to providing services related to multimedia applications, and may provide services related to applications not described and/or illustrated herein.

System 200 may include circuitry 202. As used herein, circuitry 202 may refer to one or more circuits to implement functionality. Circuitry 202 may be programmed with instructions to perform the functionality. Additionally, circuitry 202 may comprise memory 230, such as read-only and/or random access memory that may store, and/or be programmed with machine-executable instructions 232 to perform the functionality. In either case, the machine-executable instructions 232, when executed, may result in the operations described in the blocks of the methods herein as being carried out by circuitry 202. Circuitry 202 may comprise one or more digital circuits, one or more analog circuits, a state machine, programmable circuitry, and/or one or more ASIC's (application specific integrated circuits).

Of course, as understood by one of ordinary skill, functionality implemented in circuitry 202 may additionally, and/or alternatively, be implemented in software as machine-executable instructions. Thus, operations that may be described as being carried out by circuitry may alternatively, and/or additionally, be performed by a general-purpose or special-purpose processor or logic circuits programmed with the machine-executable instructions when the machine-executable are instructions executed.

System 200 may additionally comprise one or more applications 204, 206, 208, one or more resources 214, 216, 218, and one or more databases 224 (only one shown). One or more clients 210, 212 may communicate with system 200 to request one or more services (hereinafter “service request”) from system 200. Clients may include STBs, HDTVs (high definition television), PDAs (personal digital assistants), tablet PCs, laptop or desktop PCs, multiple TVs, image capture devices, external storage, stereos, and home theaters, and/or other devices not listed, and/or that may exist now or in the future. System 200 and each client 210, 212 may be a node 102A . . . 102N in network 100. System 200 may additionally comprise a network interface card 228 (hereinafter “NIC”) to allow system 200 to communicate over medium 104 with one or more clients 210, 212, and vice versa.

Service request 220, 222 may be associated with an application 204, 206, 208. A service request 220, 222 associated with an application 204, 206, 208 may be a request referring to a service provided by system 200 that results from execution of application 204, 206, 208. A service, as used herein, may refer to a process that results in the transfer of content between system 200, and one or more clients 210, 212. In described and illustrated embodiments, an application 204, 206, 208 may comprise a multimedia application, and content may comprise multimedia content, such as video, voice, picture, text, or any combination of these. In these embodiments, a service may include, for example, downloading (i.e., loading data from MIMC 200 to a client 210, 212) pictures (multimedia content) from a server, or broadcasting a conference (where the multimedia content may comprise a live or taped video of the conference). However, embodiments of the invention do not necessarily limit applications to multimedia applications, and do not necessarily limit content to multimedia content. Also, while application 204, 206, 208 is shown to reside on system 200, application 204, 206, 208 need not reside on system 200.

In one embodiment, for example, service request 220, 222 from client 210, 212 to system 200 may comprise an association request frame. Association request frame may include information, such as client information, and may specify one or more services being requested. System 200 may acknowledge the association request frame by sending an association response frame to client 210, 212 with information about one or more resources 214, 216, 218 that circuitry 202 has allocated to support the application 204, 206, 208 associated with the service request 220, 222 of the association request frame. After the association request and association response handshake between client 210, 212 and system 200, system 200 may transfer packets, which may be packets in network 100 described above, containing content, to client 210, 212. The association request frame, association response frame, and packets containing content may each be formatted as an MSDU (MAC—media access layer—service data unit).

As used herein, a resource 214, 216, 218 refers to tangible or intangible means that may be allocated to an application 204, 206, 208 to support the execution of the application 204, 206, 208. As used herein, means may be singular or plural. A described below, a resource, may comprise, as examples, processing throughput, queue length, and/or memory buffer size.

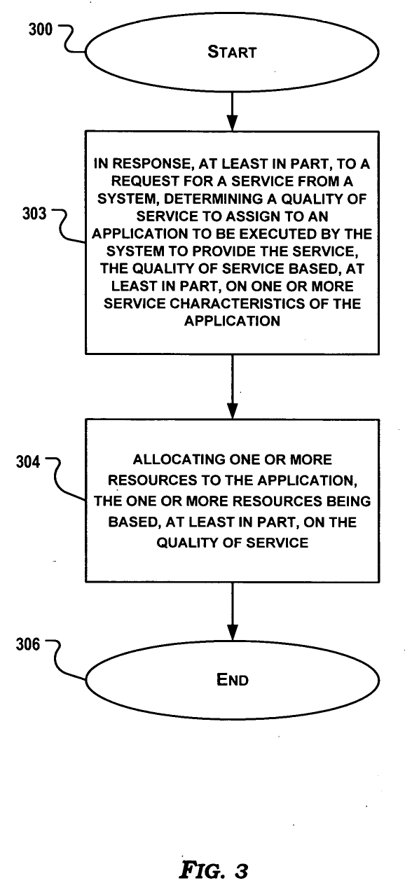

A method in accordance with an embodiment of the invention is shown in FIG. 3. The method of FIG. 3 begins at block 300, and continues to block 302 where circuitry 202, in response, at least in part, to a service request 220, 222 from a client 210, 212, respectively, may determine a quality of service to assign to an application 204, 206, 208 to be executed by system 200 to provide the service, the quality of service based, at least in part, on one or more service characteristics of the application. At block 304, circuitry 202 may allocate one or more 214, 216, 218 resources to application 204, 206, 208 based, at least in part, on the quality of service. The method ends at block 306.

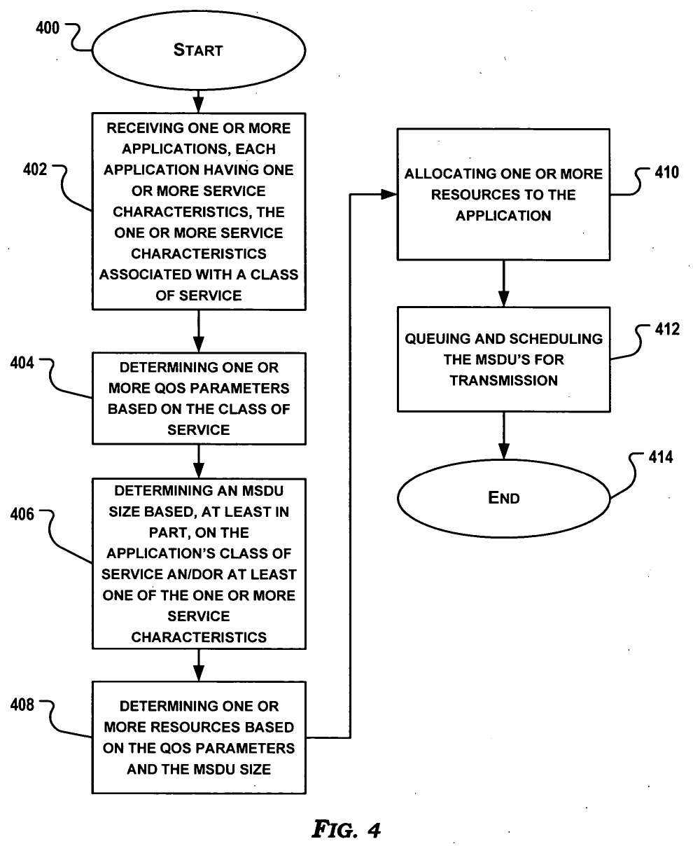

FIG. 4 is a flowchart illustrating a method in accordance with another embodiment of the invention. The method begins at block 400. At block 402, circuitry 202 may receive one or more applications 204, 206, 208, each application having one or more service characteristics, and the one or more service characteristics associated with a class of service. In one embodiment, for example, each application 204, 206, 208 may provide a description of its requirements to circuitry 202 in terms of its one or more service characteristics. Circuitry 202 may then map the one or more service characteristics to a class of service database (not shown), for example, which may include a plurality of classes of service, where each class of service corresponds to one or more service characteristics to which the application service characteristics can be mapped to determine the application's class of service. In another embodiment, for example, each application 204, 206, 208 may inform circuitry 202, such as via a header in a packet, as to its class of service.

At block 404, circuitry 202 may determine one or more QoS parameters to assign to the application based, at least in part, on the class of service by mapping the class of service to one or more QoS parameters that may be located in QoS parameters database 224. At block 406, circuitry 202 may determine an MSDU size to assign to application based, at least in part, on the application's class of service and/or at least one of the one or more service characteristics. The MSDU size may be the size of each packet to be transmitted from system 200 to client 210, 212. Circuitry 202 may use service characteristics of the application 204, 206, 208, such as delay or latency information, and/or a priority associated with the application's 204, 206, 208 class of service, to determine the MSDU size. For example, for low latency classes of service such as conversational video or conversational voice, circuitry 202 may assign a small packet size, and for classes of service that support large latency (e.g., background class of service), circuitry 202 may assign a larger packet size.

At block 408, circuitry 202 may determine one or more resources to assign to the application based, at least in part, on the QoS parameters and MSDU size. At block 410, circuitry 202 may allocate one or more resources to the application, and at block 412, circuitry 202 may queue and schedule the MSDUs for transmission to a requesting client. The method ends at block 414.

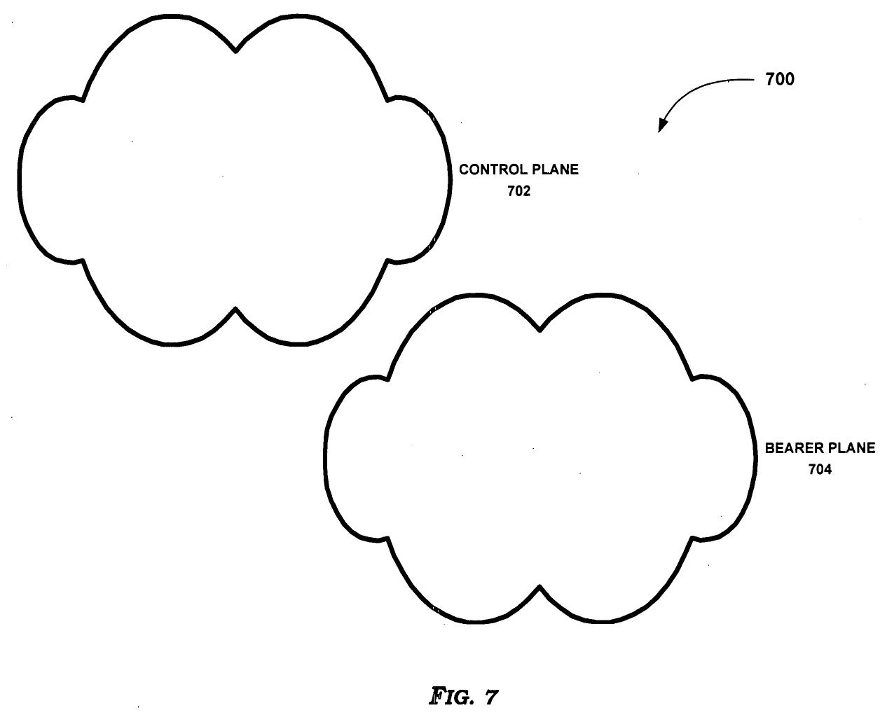

Embodiments of the invention may allow applications to be serviced outside of the control plane (i.e., call control and signal processing). As illustrated in FIG. 7, communication environment 700 may be thought of having a control plane 702 and a bearer plane 704. Embodiments of the invention may enable applications to be serviced in the bearer plane 704, where applications may be assigned a QoS, and allocated resources independently of signal processing and call control (i.e., control plane 702), and instead, serviced in the same plane as data transmission.

Embodiments of the invention may be compatible with standards that support QoS functions. For wireless standards, that may include, for example, IEEE (Institute of Electrical and Electronics Engineers) 802.11e. IEEE 802.11e may be a WLAN (Wireless Local Area Network) 802.11 proposed standard, based on the IEEE 802.11 standard, that may add a MAC (medium access control) layer specification for applications and QoS support. The IEEE 802.11e proposed standard is published in IEEE P802.11, Wireless LAN's, “802.11e Draft Standard D 1.0 Letter Ballot 27 Comments, Clause 5”, LB27 Comments and Revisions, Revision 0—Jul. 16, 2001, Revision 3—Oct. 5, 2001. The current 802.11 specification is published in ANSI (American National Standards Institute)/IEEE Std. 802.11, 1999 Edition, “IEEE Standards for Information Technology—Telecommunications and Information Exchange between Systems—Local and Metropolitan Area Network—Specific Requirements—Part 11: Wireless LAN Medium Access Control (MAC) and Physical Layer (PHY) Specifications”. For wireless standards, NIC 228 may be a wireless NIC.

For wirelined standards, other standards and/or proposed standards with which current embodiments of the invention may be compatible include flow aggregation as in the case of differentiated services; flow control management as in the case of RSVP; or Multi-Protocol Label Switching (MPLS), the proposed standard which is published in “Multiprotocol Label Switching (MPLS) Management Overview”, Thomas D. Nadeau, Cisco Systems, Inc., Cheenu Srinivasan, Bloomberg L. P., Adrian Farrel, Old Dog Consulting, September, 1999, where IP packets may be tagged with labels that specify priority and route. For wirelined standards, NIC 228 may be a wirelined NIC. Determining A Quality of Service To Assign To A Multimedia Application

Determining a quality of service to assign to an application 204, 206, 208 may comprise determining one or more QoS parameters, and determining the size of the MSDUs.

### Determining QoS Parameters

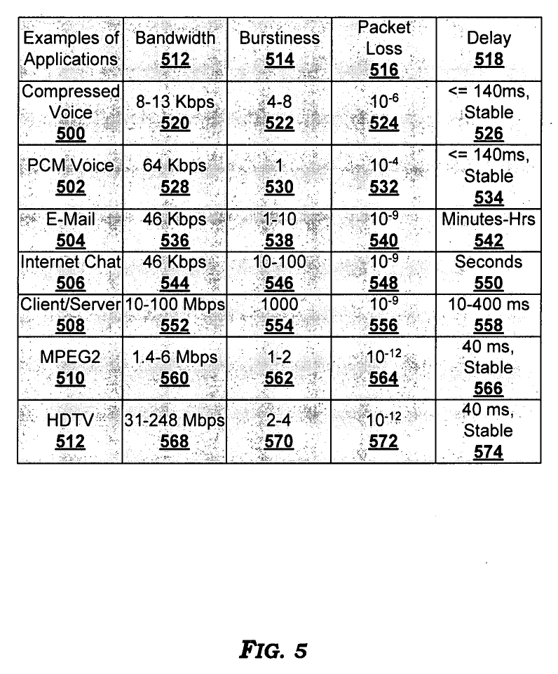

One or more QoS parameters may be determined based, at least in part, on a class of service associated with an application 204, 206, 208. In one embodiment of the invention, one or more QoS parameters may be determined by mapping an application's class of service to one or more QoS parameters. With reference to FIG. 5, examples of service characteristics of a multimedia application 204, 206, 208 may include the following:
“Bandwidth” 512 may mean an amount of data that may be transmitted in a communications channel in a given period of time.
“Burstiness” 514 may refer to a peak to average bit rate ratio. For example, services that use all of the bandwidth all of the time have a burstiness of one.
“Packet loss” 516 may refer to an amount of information that can be lost without substantial risk of failure of the service and/or customer complaints. For example, voice services can accommodate higher packet loss tolerance than data services.
“Delay” 518 may refer to the time sensitivity of the service that may occur without significant degradation in performance, as may be perceived by users. Delay may be measured by the time a request is made to the time when the request is serviced. For example, for synchronous or isochronous services, such as voice and video, delay should be within specified limits. On the other hand, background services, such as email, chat, and web browsing, can accommodate much higher delay.

A multimedia application 204, 206, 208 may be associated with fewer, or more, service characteristics than the examples described above without departing from embodiments of the invention.

FIG. 5 lists examples of several types of multimedia applications 204, 206, 208, including compressed voice 500, PCM (pulse code modulation) voice 502, e-mail 504, Internet chat 506, client/server 508, MPEG2 (Moving Pictures Expert Group) 510, and HDTV (high-definition television) 512. Example service characteristics associated with the multimedia applications 204, 206, 208 include bandwidth 512 (including 520, 528, 536, 544, 552, 560, 568, respectively, for the multimedia applications 500, 502, 504, 506, 508, 510, 512 described above); burstiness 514 (including 522, 530, 538, 546, 554, 562, 570, respectively, for the multimedia applications 500, 502, 504, 506, 508, 510, 512 described above); packet loss 516 (including 524, 532, 540, 548, 556, 564, 572, respectively, for the multimedia applications 500, 502, 504, 506, 508, 510, 512 described above); and delay 518 (including 526, 534, 542, 550, 558, 566, 574, respectively, for the multimedia applications 500, 502, 504, 506, 508, 510, 512 described above).

In one embodiment, each (and any) multimedia application, including multimedia applications 500, 502, 504, 506, 508, 510, 512, may be mapped (either by the application, or by system 200) to a class of service. A class of service to which an application may be mapped is said to be associated with the application. Classes of service may be predefined. In one embodiment, for example, each type of multimedia application may be mapped to one of the following classes of service: conversational voice, conversational video, conversational data, streaming audio, streaming video, streaming data, interactive, and background. As one of ordinary skill in the art would appreciate, these classes of service are exemplary, for illustrative purposes only, and are not intended to limit embodiments of the invention.

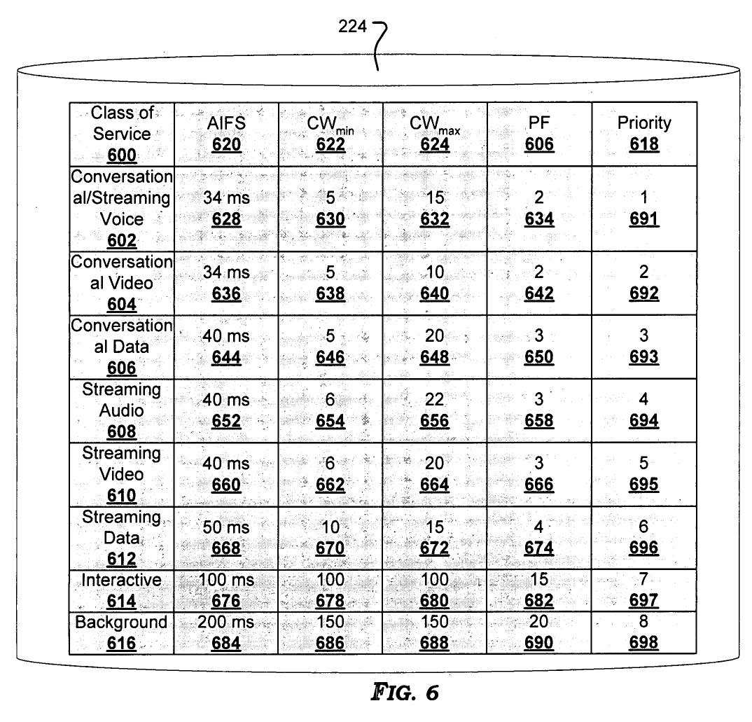

FIG. 6 is an exemplary QoS parameters database 224 for wireless communications using IEEE 802.11e. Circuitry 202 may map a class of service associated with an application to one or more QoS parameters. For each class of service, QoS parameters may comprise:

AIFS (Arbitration Inter Frame Space) 620: each class of service may contend for a transmission opportunity and may independently start a backoff after detecting the channel being idle for AIFS period. This parameter may have a value of at least 34 microseconds (psec). Example AIFS values 628, 636, 644, 652, 660, 668, 676, 684 are indicated for each class of service 602, 604, 606, 608, 610, 612, 614, 616, respectively.

CWₘᵢₙ and CWₘₐₓ (Contention Window) 622, 624: a backoff counter. After waiting for AIFS period, each backoff may set a counter to a random number drawn from the interval [1, CW+1]. CWₘᵢₙ and CWₘₐₓ may be the bounds of CW, and may have a value between 0 to 255. Example CWₘᵢₙ values 630, 638, 646, 654, 662, 670, 678, 686 are indicated for each class of service 602, 604, 606, 608, 610, 612, 614, 616, respectively. Example CWₘₐₓ values 632, 640, 648, 656, 664, 672, 680, 688 are indicated for each class of service 602, 604, 606, 608, 610, 612, 614, 616, respectively.

PF (Persistence Factor) 626: a factor by which a new CWₘᵢₙ and CWₘₐₓ after any unsuccessful transmission attempt may be calculated. After any unsuccessful transmission attempt, new CWₘᵢₙ and CWₘₐₓ may be calculated based, at least in part, on PF, and another uniformly distributed backoff counter out of the new enlarged CWₘᵢₙ and CWₘₐₓ may be drawn to reduce the probability of a new collision. For example, if CWₘₐₓ is 16 and PF=2, after contention, CWₘₐₓ may be increased to 32 and a new value of backoff counter may be a random number drawn from [0, 32]. PF parameter may have a value between 1 and 16. Example PF values 634, 642, 650, 658, 666, 674, 682, 690 are indicated for each class of service 602, 604, 606, 608, 610, 612, 614, 616, respectively.

Each class of service 600 (class of service examples 602, 604, 606, 608, 610, 612, 614, 616) may additionally be associated with a priority 618. In one embodiment, as illustrated in FIG. 6, each class of service 602, 604, 606, 608, 610, 612, 614, 616 may be assigned a unique priority 1 (691), 2 (692), 3 (693), 4 (694), 5 (695), 6 (696), 7 (697), and 8 (698). In another embodiment, one class of service may be assigned a priority which may be the same priority as another class of service. Also, a class of service associated with smaller values of QoS parameters may be assigned a higher priority. This may allow applications 204, 206, 208 associated with the class of service to achieve higher throughput because the smaller QoS parameters may enable the multimedia application to get faster access to the channel.

### Determining MSDU Size

Circuitry 202 may determine the size of the MSDU in accordance with an application's 204, 206, 208 class of service and/or at least one application's 204, 206, 208 one or more service characteristics. In one embodiment, application's 204, 206, 208 class of service and/or at least one application's 204, 206, 208 one or more service characteristics may be used to determine MSDU size to reduce delay in transmitting data associated with the application 204, 206, 208. Generally, delay may be impacted by one or more of the following: packetizing delay, serial delay, and processing throughput delay. Each of these types of delay, and how the MSDU size may mitigate the delays, are described below:

Packetizing delays may refer to delays that are caused by waiting for an MSDU to completely load before an information packet can be transmitted. Specifying a smaller MSDU packet size may help to minimize this type of delay, since a smaller MSDU may load faster. This may enable faster packet transmission, and thereby faster processing of the request.

Serial delays may be defined as the bit transmission delay associated with highly variable length data units. To minimize serial delays, a small MSDU packet size may be assigned to applications associated with a high priority class of service, and a larger MSDU packet size may be assigned applications associated with a low priority class of service. Since lower priority classes may not need to meet latency or delay requirements, larger sized packets may be formed before transmission over the wireless channel.

Processing throughput delay may also be impacted by the size of an MSDU. Processing throughput delay may be defined as the delay associated with processing (i.e., transferring data from system to client) data in a specified amount of time. Thus, in 802.11 wireless protocol, for example, the larger the MSDU size, the higher the achievable throughput since on channel acquisition, a larger amount of data may be transferred.

Allocating Resources

Resources 214, 216, 218 may include processing throughput, queue length, and memory buffer size. Processing throughput may be defined as the number of instructions (typically called MIPS, or millions of instructions per second) to process an MSDU, and may depend on the processing power of the system being used, as well as packet processing activity, such as header formation and CRC (cyclic redundancy check), for example. Queue length may be the number of MSDUs that may be queued prior to transmission of data in the queue. Memory buffer size may be defined as how much data system 200 can store prior to transmission of packets from system 200 to client 210, 212.

Based, at least in part, on how often system 200 allocates a wireless channel to applications 204, 206, 208, system 200 may determine how much data (where this amount may be measured in MIPS, for example) it can store before it transfers the data to client 210, 212 on the wireless channel. How often system 200 may allocate a wireless channel may be an average period of time it has been allocating a wireless channel on previous transmissions, a predetermined period of time, or a calculation based, at least in part, on a current application's QoS parameters, for example. The amount of data that can be transferred may be used to determine what size memory buffer to allocate to the application 204, 206, 208. The memory buffer may be used in conjunction with the MSDU size to determine a queue length to allocate to the application 204, 206, 208.

For example, if a particular application 204, 206, 208 is mapped to a class of service associated with a data rate of 1 Mbps (i.e., a service characteristic of 1 megabit, or 1,000,000 bits per second), and system 200 may allocate a wireless channel once every 100 ms (100 milliseconds, or 1/100 of a second) on average, then the memory buffer may be calculated as follows:
1,000,000/100=10,000 bits per millisecond (i.e., a million bits per second is equivalent to 10,000 bits per millisecond).
10,000/8=1250 bytes (i.e., 10,000 bits is equal to 1250 bytes).

In this example, the memory buffer size may be set to 1250 bytes. This may mean that system 200 may store 1250 bytes of data in its memory prior to transmitting the data to client 210, 212.

Furthermore, if the MSDU size is calculated to be 1000 bytes (as determined by one or more service characteristics of the application, for example), then the queue length may be calculated as follows:
1250/1000=1.25.

This number may be rounded up to the next whole number, which may be the queue length.

Thus, in the example shown above, system 200 may allocate the following resources to client 210, 212 requesting an application 204, 206, 208 having a service characteristic of 1 Mbps:
Processing throughput=assuming it takes X instructions to process a single packet (including, for example, forming packet header and checking CRC), and there are 1000 MSDUs, then it will take 1000× instructions to process the MSDUs;
Queue length=2; and
Memory buffer size=1250 bytes
   Queuing and Scheduling

Circuitry 102 may queue the MSDUs in queues in accordance with the priority of the corresponding class and the queue length, for instance. In the example above, 2 MSDUs may be stored in a queue. When system 200 allocates the channel, the queue may be emptied in accordance with a queuing mechanism. Various queuing mechanisms may be compatible with embodiments of the invention, including class-based weighted fair queuing (CBWFQ), strict priority queuing (SPQ), and priority-based class based weighted fair queuing (PBCBWFQ), for example. In CBWFQ and SPQ, each queue may hold MSDU's corresponding to a particular class of service, where each class of service may be associated with a priority. In CBWFQ, low bandwidth packets may have priority over high bandwidth packets, but may be weighted by its associated class of service. In SPQ, higher priority queues may be serviced before lower priority queues. In PBCBWFQ, queues are grouped according to priorities, with class-based queuing within each priority. System 200 may deliver the MSDUs in accordance with the allocated processing throughput.

Conclusion

Thus, in one embodiment, a method comprises in response, at least in part, to a request for a service from a system, determining a quality of service to assign to an application to be executed by the system to provide the service, the quality of service based, at least in part, on one or more service characteristics of the application, and allocating one or more resources to the application, the one or more resources based, at least in part, on the quality of service.

In embodiments of the invention, resources may be assigned to various applications based, at least in part, on the type of service offered by a particular application in order to prevent and control congestion in the network. Furthermore, by using an assigned quality of service to determine resources, QoS management functions may be defined in the bearer plane. By implementing QoS management functions in the bearer plane, the costs of context switching and data movement may be reduced. For example, moving packets using system calls may be expensive. Furthermore, handling events as they occur, as would be done in the control plane, may lead to excessive context switching.

In the foregoing specification, the invention has been described with reference to specific embodiments thereof. It will, however, be evident that various modifications and changes may be made to these embodiments without departing therefrom. The specification and drawings are, accordingly, to be regarded in an illustrative rather than a restrictive sense.

1. A method comprising:
in response, at least in part, to a request for a service from a system, determining a quality of service to assign to an application to be executed by the system to provide the service, the quality of service based, at least in part, on one or more service characteristics of the application; and
allocating one or more resources to the application, the one or more resources being based, at least in part, on the quality of service.

2. The method of claim 1, wherein the system comprises a modified intelligent media center (MIMC), and said determining a quality of service to assign to an application to be executed by the system to provide the service comprises determining a quality of service to assign to a multimedia application to be executed by the MIMC to provide the service.

3. The method of claim 2, wherein said determining the quality of service to assign to the multimedia application comprises assigning one or more QoS (quality of service) parameters to the application, the QoS parameters being based on a class of service associated with the one or more service characteristics of the multimedia application.

4. The method of claim 3, wherein the multimedia application is a wireless application, and the one or more QoS parameters comprise at least one of:
AIFS (arbitration inter-frame space);
CWₘᵢₙ (minimum contention window);
CWₘₐₓ (maximum contention window); and
PF (persistence factor).

5. The method of claim 3, wherein said determining the quality of service to assign to the multimedia application additionally comprises determining a size of packets to be used for transmitting data associated with the multimedia application from the system to a client.

6. The method of claim 5, wherein said determining the size of packets comprises determining a size of an MSDU (MAC—media access layer—service data unit) based, at least in part, on at least one of the one or more service characteristics.

7. The method of claim 6, wherein said determining the size of the data packets additionally comprises determining the size of the MSDU based, at least in part, on a priority associated with the class of service.

8. The method of claim 1, wherein said allocating the one or more resources to the application based, at least in part, on the quality of service comprises assigning at least one of:
a processing throughput;
a queue length; and
memory buffer size.

9. The method of claim 1, additionally comprising:
queuing the application for servicing; and
scheduling the application for servicing.

10. An apparatus comprising:
circuitry capable of:
in response, at least in part, to a request for a service from a system, determining a quality of service to assign to an application to be executed by the system to provide the service, the quality of service based, at least in part, on one or more service characteristics of the application; and
allocating one or more resources to the application, the one or more resources based, at least in part, on the quality of service.

11. The apparatus of claim 10, wherein the system comprises a modified intelligent media center (MIMC), and the circuitry that is capable of determining a quality of service to assign to an application to be executed by the system to provide the service is capable of determining a quality of service to assign to a multimedia application to be executed by the MIMC to provide the service.

12. The apparatus of claim 11, wherein said circuitry capable of determining the quality of service to assign to the multimedia application is also capable of assigning one or more QoS (quality of service) parameters to the multimedia application.

13. The apparatus of claim 12, wherein the multimedia application is a wireless application, and the one or more QoS parameters comprise at least one of:
AIFS (arbitration inter-frame space);
CWₘᵢₙ (minimum contention window);
CWₘₐₓ (maximum contention window); and
PF (persistence factor).

14. The apparatus of claim 12, wherein said circuitry capable of determining the quality of service to assign to the multimedia application is also capable of determining a size of packets to be used for transmitting data associated with the multimedia application from the system to a client.

15. The apparatus of claim 10, wherein said circuitry capable of allocating the one or more resources to the application based, at least in part, on the quality of service is also capable of assigning at least one of:
a processing throughput;
a queue length; and
memory buffer size.

16. The apparatus of claim 10, additionally said circuitry additionally capable of:
queuing the application for servicing; and
scheduling the application for servicing.

17. A system comprising:
one or more applications to be executed to provide one or more services to one or more clients;
one or more resources to support the execution of the one or more applications;
a wireless network interface card to receive from the one or more clients, one or more requests for a service; and
circuitry communicatively coupled to the wireless network interface card, and capable of:
in response, at least in part, to a request for a service, determining a quality of service to assign to one of the applications to provide one of the one or more services, the quality of service based, at least in part, on one or more service characteristics of the application; and
allocating at least one of the one or more resources to the application, the at least one of the one or more resources based, at least in part, on the quality of service.

18. The system of claim 17, wherein the system comprises a modified intelligent media center (MIMC), and the circuitry that is capable of determining a quality of service to assign to an application to be executed by the system to provide the service is capable of determining a quality of service to assign to a multimedia application to be executed by the MIMC to provide the service.

19. The system of claim 18, wherein said circuitry capable of determining the quality of service to assign to the multimedia application is also capable of assigning one or more QoS (quality of service) parameters to the multimedia application.

20. The system of claim 19, wherein said circuitry capable of determining the quality of service to assign to the multimedia application is also capable of determining a size of packets to be used for transmitting data associated with the multimedia application from the system to the client.

21. The system of claim 17, wherein said circuitry capable of allocating the one or more resources to the multimedia application based, at least in part, on the quality of service is also capable of assigning at least one of:
a processing throughput;
a queue length; and
memory buffer size.

22. The system of claim 17, additionally said circuitry additionally capable of:
queuing the application for servicing; and
scheduling the application for servicing.

23. The system as in claim 17, wherein said circuitry is capable of operating in a bearer plane of a communications environment.

24. A machine-readable medium having stored thereon instructions, the instructions when executed by a machine, result in the following:
in response, at least in part, to a request for a service from a system, determining a quality of service to assign to an application to be executed by the system to provide the service, the quality of service based, at least in part, on one or more service characteristics of the application; and
allocating one or more resources to the application, the one or more resources based, at least in part, on the quality of service.

25. The machine-readable medium of claim 24, wherein the system comprises a modified intelligent media center (MIMC), and said instructions that result in determining a quality of service to assign to the application result in determining a quality of service to assign to a multimedia application to be executed by the MIMC to provide the service.

26. The machine-readable medium of claim 25, wherein said instructions that result in determining the quality of service to assign to the multimedia application result in assigning one or more QoS (quality of service) parameters to the multimedia application.

27. The machine-readable medium of claim 26, wherein the multimedia application is a wireless application, and the one or more QoS parameters comprise at least one of:
AIFS (arbitration inter-frame space);
CWₘᵢₙ (minimum contention window);
CWₘₐₓ (maximum contention window); and
PF (persistence factor).

28. The machine-readable medium of claim 26, wherein said instructions, when executed by a machine, that result in determining the quality of service to assign to the multimedia application additionally result in determining a size of packets to be used for transmitting data associated with the multimedia application from the system to a client.

29. The machine-readable medium of claim 24, wherein said instructions, when executed by a machine, result in allocating the one or more resources to the application based, at least in part, on the quality of service additionally result in assigning at least one of:
a processing throughput;
a queue length; and
memory buffer size.

30. The machine-readable medium of claim 24, said instructions, when executed by a machine, additionally result in:
queuing the application for servicing; and
scheduling the application for servicing.
